(19) United States
(12) Patent Application Publication
(10) Pub. No.: US 2007/0249756 A1
(43) Pub. Date: Oct. 25, 2007

(54) Flame-retardant resin composition and flame-retardant resin-molded article

(75) Inventors: Masayuki Okoshi, Minamiashigara-shi (JP); Tsuyoshi Miyamoto, Minamiashigara-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/242,026

(22) Filed: Oct. 4, 2005

(30) Foreign Application Priority Data
Jun. 24, 2005 (JP) 2005-184665

(51) Int. Cl. C08K 9/00; C08K 9/06

(52) U.S. Cl. 523/205; 523/209; 523/212

(57) ABSTRACT

A flame-retardant resin composition comprising a biodegradable resin and flame-retardant particles having a volume average particle diameter in the range of 1 nm to 500 nm dispersed in the biodegradable resin, wherein the flame-retardant particles contain a metal hydrate and have a coating layer containing an organic compound or a polysilicone, and a flame-retardant resin-molded article comprising a biodegradable resin and flame-retardant particles having a volume average particle diameter of 1 nm to 500 nm dispersed in the biodegradable resin, wherein the flame-retardant particles comprise a metal hydrate, and the flame-retardant resin-molded article has a flame retardancy of HB or higher according to the UL-94 test.

### CROSS-REFERENCE TO RELATED APPLICATION

This application claims priority under 35 USC 119 from Japanese patent Application No. 2005-184665, the disclosure of which is incorporated by reference herein.

### BACKGROUND OF THE INVENTION

1. Field of the Invention

The present invention relates to a flame-retardant resin composition and flame-retardant resin-molded article containing a biodegradable resin which is mixed with flame-retardant particles. In particular, the present invention relates to a flame-retardant resin composition and flame-retardant resin-molded article that are used for protection, from the troubles by heat such as fire, of various products including frames for consumer electronics and OA products, electric wires and cables, automobiles, ships, airplanes, and railroad trains, packaging materials, building materials, electronic devices and printed boards.

2. Description of the Related Art

Halogen compounds, antimony trioxide, phosphorus compounds, hydrated metal compounds (metal hydrates) and the like have been used as flame retardants to be mixed with resins (resin composition) so as to impart flame retardancy thereto. Among flame retardants, use of halogen compounds and antimony trioxide is declining because of environmental concern, but hydrated metal compounds can reduce the environmental load. In addition, hydrated metal compounds are naturally present in a large quantity in the soil as brucite, which is a natural mineral. Therefore, hydrated metal compounds are unlikely to degenerate the soil environment during the degradation of a biodegradable resin containing the hydrated compounds. In contrast, when a biodegradable resin contains a halogen compound, antimony trioxide, or phosphorus compound and the biodegradable resin is decomposed in the soil, the soil environment is likely to be polluted. In particular, phosphorus compounds are likely to pollute water when eluted with water from the soil.

However, the hydrated metal compound has to be used in a large amount in order to provide flame retardancy equivalent to that imparted by other organic flame-retardant compounds. Therefore, use of a large amount of the hydrated metal compound results in drastic deterioration of the physical properties of the polymer. In order to impart flame retardancy equivalent to that imparted by other organic flame retardants without deterioration of the physical properties of the polymer, it is necessary to disperse hydroxylated metal compound particles with a small diameter in a resin uniformly such that they are separated from each other without aggregation. Thus, when metal hydrate particles are mixed in a resin, it is necessary to form a uniform coating layer on the particle surface, so as to ensure the dispersion state of the particles in the resin and so as to prevent the active groups from affecting the resin composition to degrade the resin characteristics. In particular, it is known that when a weakly-alkaline flame-retardant such as magnesium hydroxide is mixed in with a resin composition containing polyester structure such as a biodegradable resin, the ester groups are hydrolyzed at the kneading by an extruder or the like, whereby the resin composition foams. The formation of a uniform coating layer on the particles of the metal hydroxide is considered necessary also for the prevention of the foaming.

Surface treatment with a higher fatty acid or the like, formation of a silica layer, and the like are known as methods for forming a coating layer on particle surface (for example in Japanese Patent Application Laid-Open (JP-A) Nos. 52-30262 and 2003-253266, the disclosures of which are incorporated herein by reference). However, when such methods are applied to nanometer-sized particles, the particle in the aggregated state undergoes coating reaction under conventional reaction conditions because the particles are difficult to disperse sufficiently and the coating reaction rate is high; as a result, uniformly coated particles are not obtained.

Further, it has been proposed to treat surface of inorganic powder with a polyamino acid or a gas-phase cyclic organosiloxane (for example in JP-A Nos. 57-145006 and 61-268763, the disclosures of which are incorporated herein by reference). These methods also result in insufficient dispersion of the particles and generation of aggregates when applied to nanometer-sized particles.

A flame-retardant polyolefin composition has been also proposed (for example in JP-A No. 10-245456, the disclosure of which is incorporated herein by reference) which contains a polyolefin, a complex metal hydroxide (flame retardant), and a silicone compound (flame-retardant aid). However, the flame retardant has a large particle diameter, and the polyolefin, complex metal hydroxide, and silicone compound are merely blended; therefore, the flame retardant and the flame retardant aid fail to provide sufficient synergistic effects.

Another flame-retardant biodegradable resin composition has been proposed, for example, in JP-A No. 2004-27079, the disclosure of which is incorporated herein by reference. In the flame-retardant biodegradable resin composition, the biodegradable resin contains at least one chemical substance selected from urea, ammonium phosphate, ammonium polyphosphate, and a guanidine compound, and the biodegradable resin is preferably a polylactate resin. However, in such a flame-retardant resin composition, a phosphorus-based flame retardant is mixed with the biodegradable resin so as to improve the flame retardancy; therefore, the flame-retardant resin composition is likely to pollute the soil environment upon degradation in the soil.

Another flame-retardant biodegradable resin composition has been proposed, for example, in JP-A No. 2004-250500, the disclosure of which is incorporated herein by reference. In the resin composition, a silicone compound is contained in a polylactate resin composition. However, a large quantity of silicone such as a polyaromatic silicone (for example, phenyl silicone) is required for imparting flame retardancy to the biodegradable resin. As a result, the cost is increased and the physical characteristics of the resin composition are severely deteriorated.

### SUMMARY OF THE INVENTION

The present invention has been made in consideration of the above problems of the conventional techniques. According to the invention, a flame-retardant resin composition and a flame-retardant resin-molded article using the flame-retardant resin composition are provided. The flame-retardant resin composition imposes less load on the environment, and has satisfactory mechanical physical characteristics. Specifically, the molded article can be produced without occurrence of foaming at the molding process. The resultant molded article does not contain a halogen or phosphorus compound, the environmental load can be reduced while maintaining sufficient flame retardancy.

In conventional techniques, flame retardancy is imparted to a resin by using flame-retardant particles having a diameter in the range of 1 to 50 μm in an amount of as great as approximately at least 50 to 150 parts by weight per 100 parts by weight of the resin. Use of the particles in such a great amount often resulted in degradation of the mechanical and electrical properties of the resin, and thus, for example, other additives or resins are blended for prevention of such degradation.

The inventors of the present invention have conducted intensive studies in consideration of the problems described above. The studies focused on such atomization of flame-retardant particles as to increase the specific surface area of the particles and as to increase the contact area of the particles with the polymer. As the result, the inventors have found that use of flame-retardant particles having a volume-average particle diameter in the range of 1 to 500 nm and optional flame-retardant aid provides, even at a lower content, flame retardancy equivalent to that imparted by a conventional flame-retardant compound having a volume-average particle diameter of approximately 0.5 to 50 μm. Based on this finding, the inventors made the present invention.

The invention provides a flame-retardant resin composition. The flame-retardant resin composition comprises a biodegradable resin and flame-retardant particles having a volume average particle diameter in the range of 1 nm to 500 nm dispersed in the biodegradable resin. The flame-retardant particles contain a metal hydrate and each have a coating layer containing an organic compound or a polysilicone.

The flame-retardant resin composition may further comprise a flame-retardant aid dispersed in the biodegradable resin. The metal hydrate may be hydrate of at least one metal selected from Mg, Ca, Al, Fe, Zn, Ba, Cu, and Ni. The flame-retardant particles may be a combination of flame-retardant particles having a volume average particle diameter of 1 nm or larger but smaller than 200 nm and flame-retardant particles having a volume average particle diameter of 200 nm to 500 nm. The flame-retardant resin composition may further comprise another flame retardant having a volume average particle diameter of larger than 0.5 μm but not larger than 50 μm dispersed in the biodegradable resin. The flame-retardant resin composition may have an expansion ratio of 100 to 103%.

The invention further provides a flame-retardant resin-molded article comprising a biodegradable resin and flame-retardant particles having a volume average particle diameter of 1 nm to 500 nm dispersed in the biodegradable resin. The flame-retardant particles comprise a metal hydrate. The flame-retardant resin-molded article has a flame-retardancy of HB or higher according to the UL-94 test (which is incorporated herein by reference).

The flame-retardant resin-molded article may have a heat generation rate which is lower than one-third of the heat generation rate of a molded article formed using the biodegradable resin which does not contain the flame-retardant particles, according to cone calorimeter measurement based on ISO5660. The flame-retardant resin-molded article may have a total light transmission of 40% to 90% according to JIS (Japanese Industrial Standard) K7105 (which is incorporated herein by reference).

In the flame-retardant resin composition of the invention, flame-retardant particles having a large specific surface area and a large area of contact with the polymer are dispersed in a biodegradable resin. Accordingly, foaming does not occur during the molding, the mechanical physical characteristics are maintained, and the environmental load is reduced. The flame-retardant resin-molded article of the invention uses the flame-retardant resin composition.

### DESCRIPTION OF THE PRESENT INVENTION

<Flame-Retardant Resin Composition>

The flame-retardant resin composition according to the present invention comprises a biodegradable resin and flame-retardant particles containing a metal hydrate dispersed therein having a coating layer containing an organic compound or a a polysilicone, the flame-retardant particles having a volume-average particle diameter in the range of 1 nm to 500 nm.

As described above, flame-retardant particles of hydrated metal compounds or the like, which are commonly used as flame retardants, should be added to the resin composition in a greater amount than other organic flame-retardant compounds in order to obtain the same level of flame retardancy. The increased amount of the flame-retardant particles often results in drastic deterioration in the physical properties of the polymer. For prevention of the deterioration in polymer physical properties, the flame retardant should be added in a smaller amount.

The flame-retardant resin composition described above refers to a resin composition having a heat release rate which is one-third of that of the biodegradable resin which is the same as the flame-retardant resin except for that the flame-retardant particles are absent from the biodegradable resin as determined by the cone calorimeter measurement of ISO 5660 (which is incorporated herein by reference), and having a flame retardancy of HB or higher defined by UL-94 (which is incorporated herein by reference).

The flame retardancy (UL Standard) is a standard concerning the stability of electrical apparatuses specified and approved by UNDERWRITERS LABORATORIES INC. in U.S., and is a standard determined by the vertical combustion test in the UL combustion test methods. The flame retardancy is classified into V-0, V-1, and V-2 classes, and a class closer to V-0 indicates that the material has higher flame retardancy. When dropping of melt does not occur and the combustion time is 10 seconds or less to 30 seconds or less, the flame retardancy is rated as V-0 to V-1 levels, when dropping of melt occurs and the combustion time is 10 seconds or less to 30 seconds or less, the flame retardancy is rated as V-2.

It is possible to provide a flame retardancy equivalent to that of conventional halogen-based flame retardants by addition of flame-retardant particles in a small amount when the specific surface area of the particles is increased and the area of contact with polymer is increased by reducing the size of the flame-retardant particles to the nanometer size. The amount of flame-retardant particles to be added can be reduced by this method.

The hydrated metal compound used as the flame retardant reduces the quantity the generated heat at combustion by thermally decomposing to release water and dilutes the combustion gas released from the polymer at combustion. Although such effects are known to be significant only when the flame retardant is added in a larger amount, such a rule is applicable only to conventional hydrated metal compounds having a micrometer-sized particle diameter.

The inventors of the present invention have found that the hydrated metal compound reduces the quantity of the heat and dilutes the combustion gas released from the polymer at combustion more effectively at finer level when the particle diameter of the flame retardant is reduced to the nanometer order. These effects derive from the difference in the particle size (between micrometer order and nanometer order). The advantages of a smaller particle size are similar to the advantage of sprayed fine water droplets over water flowing from a watering pot in extinguishing the blaze.

When flame retardancy is imparted to a resin by the addition of a flame retardant to the polymer, usually, multiple flame retardants are used in combination. In such a case, the flame retardant used in a large amount in the resin is the primary flame retardant, and flame retardants added in smaller amounts to enhance the flame-retarding effect of the primary flame retardant are flame retardant aids.

For example, a flame retardant aid for a bromine-based flame retardant is an antimony oxide compound, and the antimony oxide compound, which has reactivity with bromine, enhances the flame retardancy imparted by the principal bromine-based flame retardant at combustion. In such a case, the flame retardant aid is used for providing an additional synergic effect by combined use with a flame retardant. For example, the flame retardant aid exerts an endothermic effect by the reaction with the bromine-based flame retardant.

Some flame retardant aids are easily carbonized at combustion to cover the surface of the polymer, thereby exhibiting two actions of blocking oxygen as well as blocking the combustible material released from the polymer. Such flame retardant aids are called char-forming compounds, and the flame-retarding effects thereof are different from the flame-retarding effect of the hydrated metal compounds.

In the invention, the flame-retarding effect can be improved further by the combination of the two different actions of the hydrated metal compound and the char-forming compound (flame retardant aid).

Specifically, the improvement of the flame retardancy achieved by use of the combination of a nanometer-sized hydrated metal compound and a char-forming compound is more significant than in the case of the combination of a conventional micrometer-sized hydrated metal compound and a char-forming compound. The combination of a nanometer-sized hydrated metal compound and a char-forming compound has the advantage given by the reduction in the size of the hydrated metal compound to the nanometer order and the effects inherent to the char-forming compound. Further, it is presumed that the hydrated metal compound, which is in the nanometer size, is located very close to the char-forming compound in the polymer to enhance the flame retarding effect.

In the invention, the flame retardant may be the combination of a nanometer-sized metal hydrate and a char-forming flame retardant aid, which shows the synergetic flame retarding effect. The flame-retardant resin composition according to the invention generates no hazardous gas during combustion and imparts a smaller environmental load during recycling.

Hereinafter, the structure or the like of the flame-retardant resin composition of the invention is described.

<Flame-Retardant Particle>

The flame-retardant particles comprise a metal hydrate and have a coating layer containing an organic compound or a polysilicone. The flame-retardant particles have a volume-average particle diameter in the range of 1 to 500 nm. The volume-average particle diameter of the flame-retardant particles is preferably in the range of 1 to 200 nm, more preferably 5 to 200 nm, still more preferably 10 to 200 nm, further more preferably 10 to 100 nm. A volume-average particle diameter of the flame-retardant particles of less than 1 nm may lead to reduction of the flame-retardancy-retaining capacity. When the volume-average particle diameter exceeds 500 nm, the particles show property similar to that of commercially available flame-retardant particles having a volume-average particle diameter of 1 μm, and thus addition thereof in a greater amount is necessary for obtaining flame retardancy.

Flame-retardant particles having a volume-average particle diameter in the range of 1 nm to 500 nm are capable of being uniformly dispersed in a resin. In addition, flame-retardant particles having a volume-average particle diameter in the nanometer order can form finer complexes, whereby a highly transparent flame-retardant resin composition can be obtained.

In the flame-retardant resin composition of the invention, there may be two or more kinds of flame-retardant particles dispersed in the biodegradable resin. In that case, the flame-retardant particles preferably include a kind of flame-retardant particles having a volume average particle diameter of 1 nm or larger but smaller than 200 nm and another kind of flame-retardant particles having a volume average particle diameter of 200 to 500 nm. When there are two or more kinds of flame-retardant particles having different volume average particle diameters as described above, the mechanical strength of the flame-retardant resin-molded article (which will be described later) which uses the flame-retardant resin composition of the invention is further improved.

The metal hydrate is preferably a hydrate of at least one metal selected from the group consisting of Mg, Ca, Al, Fe, Zn, Ba, Cu, and Ni. Such metal hydrates are easy to atomize, stable as hydrate, and excellent in heat absorbing property and dehydration reactivity upon heating. Among the metal hydrates described above, a hydrate of Mg, Al, or Ca is particularly preferable.

The hydrate of such a metal is not particularly limited as long as it has a flame-retardant component. Specific examples of the metal hydrate include: metal hydrates such as aluminum hydroxide, magnesium hydroxide, calcium hydroxide, iron hydroxide, zinc hydroxide, copper hydroxide, and nickel hydroxide; hydrates of calcium aluminate, gypsum dihydrate, zinc borate, and barium metaborate; and complex hydrates obtained by combinations of some of the above hydrates. Among the above hydrates, magnesium hydroxide, aluminum hydroxide, and calcium hydroxide are preferable.

The metal hydrate may be a complex metal hydrate containing two or more metals selected from Mg, Ca, Al, Fe, Zn, Ba, Cu and Ni. Such a complex metal hydrate is effective in improving the flame retardancy. For example, the combination of Mg and Ni or Fe dehydrogenates the hydrocarbons derived from resin components vaporized during combustion, thus improving the flame-retarding effects of the resin composition and suppressing smoke generation. The combination of Mg and Al adjusts the water-releasing temperature during combustion, thus improving the flame-retarding effects.

In the invention, when a metal hydrate containing Mg and one or more metals other than Mg is used as the metal hydrate, the metal hydrate is preferably represented by the following Formula (1):
MgMx-(OH)y Formula (1)

In the formula (1), M represents one or more metals selected from Ca, Al, Fe, Zn, Ba, Cu and Ni; x is a real number of 0.1 to 10; and y is an integer of 2 to 32.

M is preferably Ca, Al, Fe, Zn, Ba, Cu, or Ni; and MgAlx, MgCax, MgZnx, MgFex, or Mg(Al.Ca)x is more preferable as MgMx.

In the formula (1), x is preferably a real number of 0.1 to 5, more preferably a real number of 2 to 3. In the formula (1), y is preferably an integer of2 to 10, more preferably 2 or3.

The flame-retardant particle of the invention has a uniform coating layer which prevents the foaming of the resin composition containing a polyester structure such as a biodegradable resin and which improves the dispersion state of the nano-size flame-retardant particles in the resin composition. Such a flame retardant particle is hereinafter occasionally referred to as “surface-coated flame-retardant particle.” When the coating layer is provided, the flame-retardant component can be contained in the metal hydrate particle stably and the compatibility with the resin composition can be improved largely. In the biodegradable resin composition of the invention, the coating layer comprises an organic compound or a polysilicone.

The organic compound described above is not particularly limited, but preferably has an organic group capable of binding to the flame-retardant particles. Binding of the organic groups enables formation of a uniform organic thin layer on the surface of the flame-retardant particles.

The organic compound preferably has, at a terminal thereof, a binding group for combining with the flame-retardant particles.

Examples of the binding group include a hydroxyl group, a phosphoric acid group, a phosphonium salt group, an amino group, a sulfuric acid group, a sulfonic acid group, a carboxylic acid group, a hydrophilic heterocyclic group, a polysaccharide group (such as sorbitol, sorbit, sorbitan, sucrose ester, and a sorbitan ester residue), a polyether group (such as a polyoxyalkylene group whose alkylene moiety has 2 to 4 carbon atoms such as polyoxyethylene or polyoxypropylene), a hydrolyzable groups (such as an alkoxy group having 1 to 4 carbon atoms such as methoxy, ethoxy, propoxy, isopropoxy, or butoxy), and a halogen atom (such as bromine or chlorine).

When the binding group is an anionic group (such as sulfuric acid group, sulfonic acid group, or carboxylic acid group), the binding group may form a salt with a base. Examples of the base include inorganic bases (e.g., an alkali-earth metal such as calcium or magnesium, an alkali metal such as sodium or potassium, and ammonia), and organic bases (e.g., amines). When the binding group is a cationic group (e.g., amino group), the binding group may form a salt with an acid such as an inorganic acid (e.g., hydrochloric acid or sulfuric acid), or an organic acid (e.g., acetic acid). Further, the cationic group may form a salt with an anionic group (in particular, carboxylic acid or sulfuric acid). In an embodiment, the binding group has a cationic group and an anionic group.

Thus, preferable binding groups include ionic groups (anionic groups and cationic groups) and hydrolyzable groups, and the bond between the binding group and the flame-retardant particles may be an ionic or covalent bond.

Examples of the organic group in the organic compound include a group functioning as the hydrophobic group of a surfactant (e.g., a higher fatty acid residue, a higher alcohol residue, or an alkyl-aryl group), and a polyamino acid residue.

Examples of the higher fatty acid include a saturated fatty acid having 8 to 30 carbon atoms (preferably 10 to 28 carbon atoms, more preferably 12 to 26 carbon atoms) such as lauric acid, myristic acid, palmitic acid, arachic acid, behenic acid, rignoceric acid, cerotic acid, caprylic acid, capric acid, daturic acid, stearic acid, montanic acid, or melissic acid; and an unsaturated fatty acid having 12 to 30 carbon atoms (preferably 14 to 28 carbon atoms, more preferably 14 to 26 carbon atoms) such as elaidic acid, linolic acid, linoleic acid, linderic acid, oleic acid, gadoleic acid, erucic acid, or brassidic acid.

Examples of the higher alcohol include higher alcohol residues corresponding to the above higher fatty acid residues or the above higher fatty acids. Examples thereof include a higher alcohol residue corresponding to a higher fatty acid residue having 8 to 24 carbon atoms (preferably 10 to 22 carbon atoms, more preferably 12 to 20 carbon atoms) such as octyl, nonyl, dodecyl, tetradecyl, hexadecyl(cetyl), or octadecyl.

The alkyl-aryl group is preferably a combination of an alkyl group having 1 to 20 carbon atoms and an aryl group having 6 to 18 carbon atoms, more preferably a combination of an alkyl having 6 to 18 carbon atoms and an aryl group having 6 to 12 carbon atoms, particularly preferably a combination of an alkyl group having 6 to 16 carbon atoms and a phenyl group. Examples thereof include hexylphenyl, octylphenyl, nonylphenyl, decylphenyl, dodecylphenyl, isopropylphenyl, butylphenyl, amylphenyl, and tetradecylphenyl.

These hydrophobic groups may be substituted by various substituents (e.g., alkyl groups having 1 to 4 carbon atoms).

The polysilicone is not particularly limited as long as it has a siloxane bond, and is preferably a polymer of a cyclic organosiloxane compound represented by the following Formula (2).

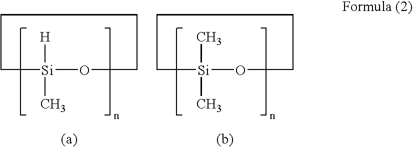

In the formula (2), n is an integer of 3 to 8. A cyclic organosiloxane having a smaller n has a lower boiling point, and evaporates more easily, whereby the amount of the cyclic organosiloxane adsorbed on the flame-retardant particle is increased. When a cyclic organosiloxane has an n of larger than 7, the cyclic organosiloxane is less volatile and cannot achieve sufficient coating in some cases. In particular, tetramers, pentamers, and hexamers are most favorable since they are easy to polymerize owing to their three-dimensional characteristics.

The cyclic organosiloxane compound (a) or (b) shown in the formula (2) may be used in the invention. As an alternative, a combination of the cyclic organosiloxane compounds (a) and (b) may be used. The polymerization degree (number of repeating units) of the polymer is preferably in the range of 10 to 1,000, more preferably 10 to 100. In an embodiment, the coating layer comprises this polymer and the organic compound described above.

Use of a polysilicone having a lower surface energy in the coating layer suppresses plasticization of the resin when the surface-coated flame-retardant particles are mixed with a resin composition.

In addition, when surface-coated flame-retardant particles are used in a flame-retardant resin composition, the surface polysilicone layer forms a heat-barrier layer during combustion. During combustion, water released from the metal hydrate particles accelerates foaming of the polysilicone coated layer (functioning as a heat-barrier layer) provided on the particle surface, thereby improving the heat insulating property of the heat-barrier layer and improving the flame-retarding effects.

In the invention, the amount of the organic compound to be coated on the flame-retardant particles is preferably in the range of 1 to 200 wt %, more preferably 20 to 100 wt %, and still more preferably 30 to 80 wt %, with respect to the entire surface-coated flame-retardant particles. A coating amount of less than 1 wt % may lead to generation of aggregates in the resin composition and uneven dispersion state. A coating amount of more than 200 wt % may lead to plasticization of the resin when the particles are dispersed therein.

The amount of the polysilicone to be coated on the flame-retardant particles is preferably in the range of 20 to 200 wt %, more preferably 20 to 80 wt %, with respect to the entire surface-coated flame-retardant particles. A coating amount of lower than 20 wt % may lead to generation of aggregates in the resin composition and uneven dispersion state. A coating amount of more than 200 wt % may lead to plasticization of the resin when the particles are dispersed therein.

The uniformity of the coating layer can be confirmed by observing the surface-coated flame-retardant particles under a transmission electron microscope.

The volume-average particle diameter (average diameter of the circumscribed circle when the surface-coated flame-retardant particles are nonspherical) of the surface-coated flame-retardant particles according to the invention is the same as described above.

The degree of dispersion of the flame-retardant particles is preferably in the range of 0.1 to 3.0. The degree of dispersion is more preferably in the range of 0.1 to 1,0 particularly preferably in the range of 0.1 to 0.8.

A smaller degree of dispersion indicates a narrower particle diameter distribution of the flame-retardant particles, i.e., more uniform distribution in particle size; and the particles having a dispersion degree in the above range give uniform flame retardancy and mechanical properties when dispersed in a resin.

The volume-average particle diameter and the degree of dispersion are determined by using a laser Doppler heterodyne-type particle diameter distribution analyzer (UPA, MICROTRAC-UPA150, manufactured by Nikkiso Co., Ltd.) (Measurements of volume-average particle diameters are conducted in the same manner hereinafter). Specifically, based on the measured particle diameter distribution, a volume weighted cumulative distribution of the particles is plotted against volume from the smaller particle diameter side, and the particle diameter at which the cumulative distribution reaches 50% point is assumed as the volume-average diameter. Similarly, a mass weighted cumulative distribution of the particles is plotted against particle weight from the smaller particle diameter side, and the particle diameter at which the cumulative distribution reaches 90% point is designated as D₉₀, and the particle diameter at which the cumulative distribution reaches 10% point is designated as D₁₀; the degree of dispersion is defined by Formula (A) below. Dispersion degree values are obtained in a similar manner hereinafter.
Degree of dispersion=log(D₉₀/D₁₀) Formula (A)

The method of producing the surface-coated flame-retardant particles according to the invention is not particularly limited if the configuration and the characteristics described above are satisfied. For example, when the coating layer includes an organic compound, a method can be employed in which metal hydrate particles are dispersed in an aqueous solution containing an organic compound metal salt and a dispersant dissolved therein to form an organic compound layer on the metal hydrate particles. When the coating layer includes a polysilicone, a method can be employed in which a vaporized organic siloxane compound is allowed to contact the surface of metal hydrate particles to form a polysilicone compound layer on the metal hydrate particles. In another method, a metal salt of an alkyl acid is added to an organic solvent to form a reverse micelle, and then the metal ion is converted to a metal oxide to form a surface-coated particle.

The amount of the flame-retardant particles contained in the flame-retardant resin composition is preferably 0.1 to 80 parts by weight (more preferably 5 to 50 parts by weight) based on 100 parts by weight of the resin composition.

<Flame Retardant Aid>

The flame retardant aid usable in the invention is not particularly limited, but is preferably at least one compound selected from the group consisting of boric-acid-based flame retardant aids, ammon-based flame retardants, other inorganic flame retardant aids, nitrogen-based flame retardant aids, other organic flame retardant aids, and colloidal flame retardant aids.

Examples of the boric-acid-based flame retardant aids include compounds containing boric acid, such as zinc borate hydrate, barium metaborate, and borax.

Examples of the ammon-based flame retardant aids include ammonia compounds such as ammonium sulfate.

Examples of other inorganic flame retardant aids include iron-oxide-based combustion catalysts such as ferrocene, titanium-containing compounds such as titanium oxide, guanidine compounds such as guanidine sulfamate, zirconium compounds, molybdenum compounds, tin compounds, carbonate salt compounds such as potassium carbonate, metal hydroxides such as aluminum hydroxide and magnesium hydroxide, and modified products thereof.

Examples of the nitrogen-based flame retardant aids include cyanurate compounds containing triazine rings.

Examples of other organic flame retardant aids include chlorendic anhydride, phthalic anhydride, compounds containing bisphenol A, glycidyl compounds such as glycidylether, polyhydric alcohols such as diethylene glycol and pentaerythritol, modified carbamides, silicone oils, and silicone compounds such as organosiloxanes.

Examples of the colloidal flame retardant aids include conventionally-used flame-resistant hydrated metal compounds such as aluminum hydroxide, magnesium hydroxide, and calcium hydroxide; calcium aluminate, calcium sulfate dihydrate, zinc borate, barium metaborate, borax, hydrates such as kaolin clay, nitrate compound such as sodium nitrate, molybdenum compounds, zirconium compounds, antimony compounds, and flame-retardant colloids such as dawsonite and phlogopite.

Only a single flame retardant aid may be used, or two or more flame retardant aids may be used in combination.

The flame retardant aid usable in the invention is preferably one or more compounds selected from boric-acid-based flame retardant aids, silicone compounds and nitrogen-based flame retardant aids because such compounds provide superior flame retardancy even when added in a relatively small amount and because such compounds are resistant to degradation at, for example, heat history during recycling.

The amount of the flame retardant aid in the flame-retardant resin composition according to the invention is preferably in the range of 0.1 to 80 parts by weight, more preferably 1 to 50 parts by weight, with respect to 100 parts by weight of the resin composition described below.

<Biodegradable Resin>

Examples of the biodegradable resin usable in the invention include aliphatic polyesters (e.g., polycaprolactone, polybutylene succinate, polyethylene succinate, polyglycolic acid, and polylactic acid), polyvinylalcohol, polyamino acid, polyurethane, and nylon oligomers. Only a single biodegradable resin may be used, or two or more biodegradable resins may be used in combination. Among them, aliphatic polyesters are preferable from the viewpoints of the smoothness of the surface of the molded article and the transparency of the molded article, and polylactic acid is particularly preferable.

In addition, modified biodegradable resins that are modified with a fused polycyclic aromatic resin prepared by polycondensation of phenol, a carbonate, heavy oil or pitch, and a formaldehyde compound in the presence of an acid catalyst are preferable because the resins, which contain an additional char-forming substance, have improved flame retardancy as described above and exhibit an additional synergic flame-retarding effect when used in combination with the flame-retardant particles.

In an example, a biodegradable resin composition prepared by dispersing flame-retardant particles or the like in a biodegradable resin may be further subjected to polymer-blending with one or more other resins. The other resins may be selected from various engineering plastics such as polycarbonate, polyphenylene ether, and polyamide.

The flame-retardant resin composition according to the invention may further comprise other commonly-used additives such as a stabilizer. The additives are not particularly limited, and examples thereof include crosslinking agents, crosslinking accelerators, crosslinking acceleration aids, activators, crosslinking inbibitors, anti-aging agents, antioxidants, antiozonants, ultraviolet absorbents, photostabilizers, tackifiers, plasticizers, softeners, reinforcing agents, toughening agents, expanding agents, expansion aids, stabilizers, lubricants, mold release agents, antistatic agents, modifying agents, colorants, coupling agents, antiseptics, fungicides, modifiers, adhesives, reodorants, polymerization catalysts, polymerization initiators, polymerization inhibitors, polymerization modifiers, nucleating agents, compatibilizers, dispersants, and antifoams.

Only a single additive may be used, or two or more additives may be used in combination.

In an embodiment, the flame-retardant resin composition according to the invention comprises the flame-retardant particles described above, an optional flame-retardant aid, and particles of another (second) flame-retardant compound having a larger particle diameter than the flame-retardant particles. In this embodiment, these flame-retardant substances can be distributed throughout the resin composition since, in the polymer matrix, the smaller flame-retardant fine particles fill the gaps among the larger particles. Accordingly, the flame retardancy is further improved by this effect.

The particles of the second flame-retardant compound preferably have a volume-average particle diameter in the range of 0.5 to 50 μm, more preferably in the range of 0.8 to 40 μm, still more preferably in the range of 0.8 to 30 μm. When the volume-average particle diameter is less than 0.5 μm, the particles may be too small to form the above structure. When the volume-average particle diameter is larger than 50 μm, the mechanical characteristics of the polymer may be deteriorated.

The second flame-retardant compound is not particularly limited, and is preferably at least one compound selected from hydrated metal compounds, inorganic hydrates, nitrogen-containing compounds, and silicon-containing inorganic fillers. The hydrated metal compound is preferably a compound selected from aluminum hydroxide, magnesium hydroxide, and calcium hydroxide. The inorganic hydrate is preferably a compound selected from calcium aluminate, calcium sulfate dihydrate, zinc borate, barium metaborate, borax, and kaolin clay. The nitrogen-containing compound is preferably sodium nitrate. Further, the silicon-containing inorganic filler is preferably selected from molybdenum compounds, zirconium compounds, antimony compounds, dawsonite, phlogopite, smectite, and the like.

Only a single compound may be used as the second flame-retardant compound, or a mixture of two or more compounds may be used as the second flame-retardant compound. In addition, the second flame-retardant compound may be the same as or different from the compound constituting the inorganic fine grains to be used in the surface-coated flame-retardant particle.

The content of the particles of the second flame-retardant compound is preferably in the range of 0.1 to 200 parts by weight, more preferably 0.1 to 50 parts by weight, per 100 parts by weight of the surface-coated flame-retardant particles. When the content of the particles of the second flame-retardant compound is less than 0.1 part by weight, the content is too low to form the above structure. When the content of the particles of the second flame-retardant compound is more than 200 parts by weight, the mechanical characteristics of the polymer are deteriorated owing to the excessively large amount of the second flame-retardant compound.

Another embodiment of the flame-retardant resin composition comprises the flame-retardant particles, an optional flame-retardant aid, and a smectite having an organic moiety attached thereto. In this embodiment, the flame-retardant substances are distributed throughout the resin composition because the gaps between the smectite particles having a larger aspect ratio are filled with the flame-retardant particles which are smaller than the smectite particles.

Further, the dispersed smectite does not impair the transparency of the resin owing to the existence of the organic moiety which improves the dispersion state of the smectite particles. The flame-retardant particles of the invention are smaller than the wavelength of visible light and are dispersible in the resin uniformly. Accordingly, the resin in the above embodiment is superior in transparency.

The flame-retardant resin composition is prepared by: mixing the surface-coated flame-retardant particles, the biodegradable resin, and optional components such as the second flame-retardant compound and a stabilizer; and kneading the mixture by a kneading machine.

The kneading machine is not particularly limited. From the viewpoint of obtaining good dispersion state, the following methods are preferable: a method of dispersing the flame-retardant particles in the biodegradable resin by repetition of shearing stress and agitation by three rolls or two rolls, and a method of dispersing the flame-retardant particles by the collision force upon collision with the sidewall and shearing force, using rolls, a kneader, a Banbury mixer, an intermixer, a uniaxial extruder, or a biaxial extruder.

The kneading temperature varies depending on the matrix resin to be used, the amount of the flame-retardant particles to be added, and the like, but is preferably in the range of 50 to 450° C., more preferably in the range of 60 to 380° C.

In addition, the flame-retardant particles according to the invention have an organic layer on their surface. Accordingly, the surface-coated flame-retardant particles can be dispersed uniformly in the resin not only by mechanical mixing by a kneader, biaxial extruder, rolls, or the like, but also in a solution wherein the resin composition is dissolved or swollen.

The flame-retardant particles may be mixed with the resin together with a polymerization solvent during the polymerization of the resin in the production of the resin composition. Therefore, there is higher degree of freedom in dispersing the flame-retardant particles in the resin, and it is possible to impart flame retardancy and to maintain the mechanical strength by addition of a small amount of the flame-retardant particles. Accordingly, the flame-retardant particles of the invention are supposed to provide improved processability. Accordingly, the flame-retardant particles may be applied to various processing methods for production of a variety of products having various shapes including pellets, fibers, films, sheets, and structural parts.

The solvent for solubilizing the resin and the polymerization solvent are not particularly limited, and examples thereof include methanol, ethylformamide, nitromethane, ethanol, acrylic acid, acetonitrile, aniline, cyclohexanol, n-butanol, methylamine, n-amyl alcohol, acetone, methylethylketone, chloroform, benzene, ethyl acetate, toluene, diethylketone, carbon tetrachloride, benzonitrile, cyclohexane, isobutyl chloride, diethylamine, methylcyclohexane, isoamyl acetate, n-octane, n-heptane, isobutyl acetate, isopropyl acetate, methyl isopropyl ketone, butyl acetate, methyl propyl ketone, ethylbenzene, xylene, tetrahydrofuran, trichloroethylene, methyl ethyl ketone, methylene chloride, pyridine, n-hexanol, isopropyl alcohol, dimethylformamide, nitromethane, ethylene glycol, glycerol formamide, dimethylformamide, and dimethylsulfoxide.

Only a single solvent may be used, or two or more solvents may be used.

The mixing temperature during mixing of the flame-retardant particles and the resin is preferably in the range of 0 to 200° C., more preferably in the range of room temperature to 150° C., particularly preferably in the range of 10 to 100° C. During the mixing, pressure may be applied in accordance with the necessity but the application of pressure is not essential.

<Expansion Ratio>

As described above, in the invention, the foaming caused by hydrolysis of the biodegradable resin can be prevented by forming a layer on the surface of the metal hydrate to prohibit the reaction of the active groups on the metal hydrate surface with the polyester groups in the biodegradable resin. The expansion ratio of the flame-retardant resin composition according to the present invention is determined as the ratio of the volume of the flame-retardant resin composition to the volume of the original constituent resin composition before the addition of the flame-retardant particles or the like, and the apparent volume ratio is determined, for example, according to the method described in ASTM D-2856 (which is incorporated herein by reference) by using a “pneumatic apparent volume analyzer”.

The expansion ratio of the flame-retardant resin composition according to the invention is preferably in the range of 100 to 103%. An expansion ratio of lower than 100% may lead to insufficient flame-retardant effect. When the expansion ratio is higher than 103%, the biodegradable resin in the composition is likely to be hydrolyzed and molding is impossible in some cases.

The flame-retardant resin composition according to the invention and the method for production thereof are briefly described so far. The flame-retardant resin composition according to the invention has a high flame retardancy even when only a small amount of flame retardant is added to the resin. This is because the specific surface area of particles and the contact area thereof with polymer (resin composition) are increased by reducing the particle size of the flame retardant. The flame retardancy can be further improved by additional use of a char-forming flame retardant aid.

In addition, the flame-retardant particle according to the invention, which has a coating layer (organic compound or polysilicone) on the surface thereof, can be dispersed more uniformly in the resin and the flame retardancy is further improved.

Further, the flame-retardant resin composition according to the invention is highly flame resistant in the presence of a smaller amount of flame-retardant particles. Therefore, the flame-retardant resin composition of the invention is also superior in mechanical properties, imparts less environmental load than conventional halogen- and phosphoric ester-based flame retardants, and is superior in recycling properties owing to the resistance of the metal hydrate to decomposition by heat history. The flame-retardant particles to be used are not larger in size than the wavelength of visible light and are dispersed uniformly in a resin composition when added to the resin composition. Therefore, the flame-retardant resin composition is excellent in transparency.

<Flame-Retardant Resin-Molded Article>

The flame-retardant resin-molded article according to the invention is obtained by molding a biodegradable resin containing flame-retardant particles dispersed therein and has a flame retardancy of HB or higher according to the UL-94 test. The flame-retardant particles comprise a metal hydrate and have a volume-average particle diameter in the range of 1 nm to 500 nm.

The flame-retardant resin-molded article according to the invention is prepared by molding the flame-retardant resin composition according to the invention described above in a molding machine. The flame-retardant particles are coated with an organic compound or a polysilicone. As described above, the flame-retardant particles having a volume-average particle diameter of 1 nm to 500 nm are superior in flame retardancy and dispersion state because of the presence of a surface coating layer. Therefore, the flame-retardant resin-molded article of the invention can realize a flame retardancy of HB or higher when subjected to the UL-94 test.

One or more molding machines selected from press molding machines, injection molding machines, mold molding machines, blow molding machines, extrusion molding machines, and fiber-spinning molding machines may be used as the molding machines for production of the flame-retardant resin-molded article according to the invention. Thus, the molding may be performed by one of these molding machines, and then molding by other molding machines may be optionally conducted.

The shape of the flame-retardant resin-molded article according to the invention is not particularly limited, and may be, for example, sheet, rod, fiber, or the like. In addition, the size of the flame-retardant resin-molded article is not limited either.

The flame-retardant resin-molded article according to the invention can be used, for example, in the sheet form for packaging materials, building materials, and the like, or as a structural component for OA-device parts such as a frame or internal part for a copying machine, printer, or the like.

Hereinafter, the advantages of the use of flame-retardant resin composition as the OA-device parts for the following exemplary articles will be described briefly.

(Frame)

The flame retardant resin-molded article of the invention, which contains flame-retardant particles of a metal hydrate, does not generate hazardous gases such as halogen gases, dioxins, and cyan during combustion and has a superior flame retardancy. Thus, the resin-molded article is preferable as a constituent material for a frame, because the thickness of the frame made of the resin-molded article can be reduced owing to its high flame retardancy, high bending modulus and superior molding processability, compared to frames made of conventional molded articles. In addition, since the resin composition contains the surface-treated metal hydrate, the surface resistance of the resin composition containing the surface-treated metal hydrate is reduced, thereby imparting superior antistatic property to the surface of the frame.

Although inorganic or organic phosphorus-based flame retardants have been used conventionally in nonhalogen flame-retardant resin compositions, they are vulnerable to hydrolysis and thus, the resin compositions are often affected by the moisture in the atmosphere and have a short lifetime. In contrast, the flame-retardant resin composition according to the invention is resistant to hydrolysis and heat. Therefore, the flame retardant resin composition of the invention has a longer lifetime than the conventional nonhalogen flame-retardant resin compositions that contain a phosphorus-based flame retardant. The flame-retardant resin composition of the invention is favorable also because it is resistant to discoloration (yellowing), because the deterioration in abrasion resistance during use is prevented, and because the flame-retardant resin composition of the invention is also superior in toner resistance (oil resistance).

(Resin-Molded Articles for Internal Part)

Internal resin-molded articles are preferably superior in dimensional accuracy and in retention of the flame retardancy. Because there are heating units for fusing and fixing toner inside OA devices, the resin parts used therein are required to have heat resistance. In particular when used in areas with higher humidity, the resin composition should have resistance to hydrolysis as well as heat resistance. Since the flame-retardant particles described above are highly resistant to thermal decomposition, resins containing the flame-retardant particles have more stable heat resistance than resins containing other flame retardants. Inorganic or organic phosphorus-based flame retardants which have been conventional used in nonhalogen flame-retardant resin compositions are vulnerable to hydrolysis as described above and disadvantageously shorten the lifetime of the resin compositions. For that reason, the resin composition according to the invention, which is higher in heat resistance and hydrolysis resistance than conventional materials, is highly favorable for use as a resin-molded article for an internal part.

(ROS Frame)

The flame-retardant resin composition according to the invention is favorable for use as an ROS frame, since it is superior in dimensional accuracy. The reason for the superior dimensional accuracy is the same as in the case of the resin-molded article for an internal part. In addition, because the flame-retardant particles contained in the flame-retardant resin-molded article of the invention have a greater specific surface area, the area of contact with the polymer is larger. Moreover, since the flame-retardant particles are spherical in shape, the flame-retardant resin composition according to the invention is less anisotropic at molding, smaller in heat shrinkage ratio, and higher in mechanical strength as well as flame retardancy.

(Bearing and Gear)

The flame-retardant resin composition according to the invention is favorable for use as a bearing or gear since it is superior in lubricity and dimensional accuracy of the molding. The reason for the superior dimensional accuracy is the same as in the case of the resin-molded article for an internal part. Because the flame-retardant particles according to the invention are spherical in shape, resin compositions containing the flame-retardant particles are superior in lubricity, smaller in the anisotropy at molding, and smaller in heat shrinkage.

(Packaging Material)

The flame-retardant resin composition according to the invention is favorable for use as a packaging material for an OA device since it is superior in the stability of flame retardancy and in the dimensional accuracy of the molding. The reason for the superiority in the stability of flame retardancy and the dimensional accuracy of the molding is the same as in the case of the molded article for an internal part. Packaging materials are applied to large devices such as copying machines, whereby they are consumed in greater amounts. Thus, packaging materials preferably have smaller contents of components (such as phosphorus or halogen compounds) which impart heavy environmental load because the influence of the discarded packaging material on the soil is proportional to the amount of the packaging material used.

As described above, the flame-retardant resin-molded article according to the invention is superior in flame retardancy, and specifically, the flame-retardant resin-molded article according to the invention preferably has a heat release rate which is one-third or lower of that of the original constituent resin composition before the addition of the flame-retardant particles and the like, as determined by the cone calorimeter measurement of ISO 5660.

In addition, the flame-retardant resin-molded article according to the invention has not only a high flame retardancy, but also functions to reduce smoke generation by suppressing generation of soot (char) during combustion. Specifically, the smoke quantity generated by the flame-retardant resin-molded article according to the invention is preferably equivalent to or smaller than the smoke quantity generated by the original constituent resin composition before the addition of the flame-retardant particles and the like, as determined by the cone calorimeter measurement of ISO 5660. The term “equivalent” used herein means that the smoke quantity is in the range of ±1% of that of the original constituent resin composition.

In addition, the flame-retardant fine particles are preferably dispersed uniformly to retain the primary particle diameter in the flame-retardant resin-molded articles according to the invention. The dispersion state can be observed by measuring the light transmittance of a sheet of the flame-retardant resin composition, in accordance with JIS K7105 (which is incorporated herein by reference). A specimen of 50 mm×50 mm×100 μm (thickness) prepared by press molding or film extrusion molding is used for the measurement.

The transmittance as determined by the above test method is preferably in the range of 40 to 90% and more preferably 60 to 90%. When the transmittance is lower than 40%, the dispersion state of the flame-retardant particles is unlikely to be homogeneous and the mechanical strength is likely to be uneven. The transmittance is preferably as high as possible, but the practical upper limit is approximately 90%.

### EXAMPLES

Hereinafter, the invention will be described specifically with reference to Examples. However, the Examples should not be construed as limiting the invention.

Examples of the preparation of the flame-retardant particles for use in the invention will be described first. In addition, flame-retardant resin compositions are also prepared by using the flame-retardant particles and the properties thereof are also examined.

First, the flame-retardant particles used in the following Examples are described.

Flame-Retardant Particle 1 with No Coating

Magnesium hydroxide particles having a volume average particle diameter of 10 nm (MAGNESIA 100 H, manufactured by Ube Material Industries, Ltd.) are referred to as “flame-retardant particle 1 with no coating.”

Flame-Retardant Particle 1 with Silicone Compound Coating

200 g of the magnesium hydroxide particles having a volume average particle diameter of 10 nm (MAGNESIA 100 H, manufactured by Ube Material Industries, Ltd.) and 200 g of octamethylcyclotetrasiloxane as a cyclic organosiloxane compound are respectively put in separate glass containers. The containers are placed in a desiccator capable of pressure reduction and sealing. Then, the desiccator is deaerated with a vacuum pump to an internal pressure of 80 mm Hg and sealed tightly. Then, the desiccator is left in an environment of 60° C. for 12 hours during which the above substances are allowed to react. After the treatment, the product is taken out of the glass container, whereby surface-treated flame-retardant particles 1 with a silicone compound coating are obtained.

The obtained surface-coated flame-retardant particles have a volume-average particle diameter of 10 nm and a dispersion degree of 0.5. The amount of surface coating, as determined by weighing the surface-coated flame-retardant particles accurately, is 62 wt %, and observation under a transmission electron microscope (FEI Company Tecnai G2) confirms that the particles are coated uniformly.

Flame-Retardant Particle 1 with Organic Compound Coating

5 g of magnesium chloride hexahydrate, 5 g of aluminum chloride hexahydrate, and 20 g of sodium n-dodecylsulfate are dissolved in 1,000 ml of ion-exchange water. The solution is agitated in a homogenizer at an agitating speed of 6,000 rpm, to give a metal soap emulsion (having a micellar structure). The obtained emulsion is added to 1,000 ml of toluene as an organic solvent, and the mixture is treated in a homogenizer at 3,000 rpm, to give a reversed-micelle particle dispersion.

Observation of the reversed-micelle particles by a dynamic light-scattering particle diameter distribution analyzer shows that the reversed-micelle particles are spherical in shape and has a particle diameter of approximately 13 nm. Then, 100 g of 25 wt % ammonia water is added to the micellar dispersion while the micellar dispersion is stirred, to give a metal hydrate. Finally, the reaction solution is heated under reduced pressure so as to remove the solvent and further dried in a vacuum dryer, to give white flame-retardant particles 1 with an organic compound coating.

The obtained flame-retardant particles 1 with an organic compound coating are composite white spherical particles of magnesium hydroxide and aluminum hydroxide having a surfactant-derived coating layer on their surfaces. The flame retardant particles 1 with an organic compound have a volume-average particle diameter of 10 nm and a dispersion degree of 0.5. The surface-coating ratio, as determined by weighing the surface-coated flame-retardant particles 1 accurately, is 50 wt %, and observation under a transmission electron microscope shows that the particles are coated uniformly.

Flame-Retardant Particle 2 with No Coating

Magnesium hydroxide particles having a volume average diameter of 200 nm (manufactured by Sakai Chemical Industry Co., Ltd. MGZ-3) are referred to as “flame-retardant particles 2 with no coating.”

Flame-Retardant Particle 2 with Silicone Compound Coating

Flame-retardant particles 2 with a silicone compound coating are prepared in the same manner as the preparation of the flame-retardant particles 1 with a silicone compound coating, except that magnesium hydroxide particles having a volume average diameter of 200 nm are used as the flame-retardant particles.

The volume-average particle diameter of the obtained surface-coated flame-retardant particles is 200 nm and the degree of dispersion is 0.5. The surface coating amount, as determined by weighing the surface-coated flame-retardant particles accurately, is 40 wt %, and observation under a transmission electron microscope shows that the particles are coated uniformly.

Flame-Retardant Particle 3 with No Coating

Magnesium hydroxide particles having a volume average diameter of 800 nm (KISUMA 5A, manufactured by Kyowa Chemical Industries) are referred to as “flame-retardant particles 3 with no coating.”

Flame-Retardant Particles 3 with Silicone Compound Coating

Flame-retardant particles 3 with silicone compound coating are prepared in the same manner as the preparation of the flame-retardant particles 1 with a silicone compound coating, except that magnesium hydroxide particles having a volume average diameter of 800 nm are used as the flame-retardant particles. The volume-average particle diameter of the obtained surface-coated flame-retardant particles is 800 nm and the degree of dispersion is 0.8. The surface coating amount, as determined by weighing the surface-coated flame-retardant particles accurately, is 3 wt %, and observation under a transmission electron microscope shows that the particles are coated uniformly.

### Example 1

(Preparation and Evaluation of Flame-Retardant Resin Compositions and Flame-Retardant Resin-Molded Articles)

10 parts by weight of the flame-retardant particles 1 with a silicone compound coating and 100 parts by weight of a biodegradable resin (BIOMAX WB 100 F, manufactured by DuPont) are mixed, and then kneaded in a biaxial extruder and extruded into a strand, which is cut while hot, to give chips of the flame-retardant resin composition. The expansion ratio of the obtained flame-retardant resin composition is 100%. The obtained chips are molded in a heating press (120° C. for 10 minutes) into a sheet-shaped molded article (flame-retardant resin-molded article) having a thickness of 2 mm. The obtained molded article is evaluated as described below. The results are summarized in Table 1.

Expansion Ratio

The expansion ratio is determined by measuring the apparent volume ratio according to the method described in ASTM D-2856 (which is incorporated herein by reference) by using a “pneumatic apparent volume analyzer”.

(Evaluation of Flame-Retardant Resin-Molded Article)

Flame Retardancy Test (UL-94)

The flame retardancy test (UL-94) is performed by the vertical combustion test specified by JIS Z2391. The test is performed by using a test piece having a thickness of 2 mm. Test pieces which clear the flame retardancy test are classified into V0, V1, V2, and HB, in the order from higher flame retardancy to lower flame retardancy. On the other hand, test pieces which do not clear the test are classified as “rejected”.

Flame Retardancy Test (by Cone Calorimeter)

In the flame retardancy test (by a cone calorimeter), the relationship between combustion time and heat release rate is determined at a radiation heat of 50 kW/m² according to the method of ISO 5660, by using a cone calorimeter (Cone Calorimeter IIIC3, manufactured by Toyo Seiki Seisaku-sho, Ltd.).

Mechanical Strength Test

In the mechanical strength test, the yield stress and the bending modulus of test pieces are determined by using an autograph (V1-C, manufactured by Toyo Seiki Seisaku-sho, Ltd.) according to the method of JIS K7161 (which is incorporated herein by reference) at normal temperature and a stress rate of 50 mm/min.

Total Light Transmittance

The total light transmittance is determined according to the method of JIS K7105 by using a hazemeter (manufactured by Nippon Denshoku Co. Ltd.). The test piece used in the measurement is a film of 100 mm×100 mm×20 μm in size prepared by cutting the obtained molded article.

Appearance

The appearance of the test piece is evaluated by visual observation.

### Examples 2 to 10 and Comparative Examples 1 to 5

Flame-retardant resin-molded articles are prepared in the same manner as in Example 1, except that the type and blending amount of the flame-retardant particles, flame retardant, and flame retardant aid used in the preparation of the flame-retardant resin composition are changed as shown in Table 1. The results are summarized in Table 1.

TABLE 1

| | | | | Example | | | | | | | | |
|---|---|---|---|---|---|---|---|---|---|---|---|---|
| | | | | 1 | 2 | 3 | 4 | 5 | 6 | 7 | 8 | 9 |
| Composition | Biodegradable resin (BIOMAX WB100F, | | | 100 | 100 | 100 | 100 | 100 | 100 | 100 | 100 | 100 |
| | manufactured by DuPont) | | | | | | | | | | | |
| | Flame- | Flame-retardant particle 1 | | | | | | | | | | |
| | retardant | with no coating | | | | | | | | | | |
| | particle | Flame-retardant particle 1 | | 10 | | | 25 | 25 | 25 | 25 | 25 | 25 |
| | | with a silicone compound | | | | | | | | | | |
| | | coating | | | | | | | | | | |
| | | Flame-retardant particle 1 | | | 10 | | | | | | | |
| | | with an organic compound | | | | | | | | | | |
| | | coating | | | | | | | | | | |
| | | Flame-retardant particle 2 | | | | | | | | | | |
| | | with no coating | | | | | | | | | | |
| | | Flame-retardant particle 2 | | | | 10 | | 10 | | | | 10 |
| | | with a silicone compound | | | | | | | | | | |
| | | coating | | | | | | | | | | |
| | | Flame-retardant particle 3 | | | | | | | | | | |
| | | with no coating | | | | | | | | | | |
| | | Flame-retardant particle 3 | | | | | | | | | | |
| | | with a silicone compound | | | | | | | | | | |
| | | coating | | | | | | | | | | |
| | Flame | Zinc borate (FLAMEBLEAK ZB, | | | | | | | 5 | | | 5 |
| | retardant | manufactured by USBORAX) | | | | | | | | | | |
| | aid | Silicone-based (DC4, | | | | | | | | 5 | | |
| | | manufactured by Dow Corning | | | | | | | | | | |
| | | Toray Silicone) | | | | | | | | | | |
| | | Nitrogen-based (Melapur MC, | | | | | | | | | 5 | |
| | | manufactured by Ciba-Geigy | | | | | | | | | | |
| | | Corp.) | | | | | | | | | | |
| | Total | | | 110 | 110 | 110 | 125 | 135 | 130 | 130 | 130 | 140 |
| Expansion ratio (%) | | | | 100 | 100 | 100 | 100 | 100 | 100 | 100 | 100 | 100 |
| Evaluation | Flame | Cone | Heat release rate | 550 | 580 | 650 | 250 | 220 | 230 | 250 | 240 | 180 |
| results | retardancy | calorimeter | (KW/m²) | | | | | | | | | |
| | | UL-94 | | HB | HB | HB | V-2 | V-2 | V-2 | V-2 | V-2 | V-0 |
| | Mechanical | Yield stress | MPa | 23 | 24 | 18 | 28 | 31 | 17 | 16 | 15 | 28 |
| | properties | Bending | Gpa | 1.8 | 1.5 | 1.4 | 1.9 | 2.2 | 1.4 | 1.3 | 1.2 | 1.8 |
| | | modulus | | | | | | | | | | |

| | | | | | | | | | | |
|---|---|---|---|---|---|---|---|---|---|---|
| Total light | % | 88 | 87 | 86 | 75 | 72 | 78 | 72 | 68 | 62 |
| transmittance | | | | | | | | | | |

| | | | | | | | | | |
|---|---|---|---|---|---|---|---|---|---|
| Appearance | Natural | Natural | Natural | Natural | Natural | Natural | Natural | Natural | Natural |

| | | | | Example | Comparative Example | | | | |
|---|---|---|---|---|---|---|---|---|---|
| | | | | 10 | 1 | 2 | 3 | 4 | 5 |
| Composition | Biodegradable resin (BIOMAX WB100F, | | | 100 | 100 | 100 | 100 | 100 | 100 |
| | manufactured by DuPont) | | | | | | | | |
| | Flame- | Flame-retardant particle 1 | | | | 25 | | | |
| | retardant | with no coating | | | | | | | |
| | particle | Flame-retardant particle 1 | | 25 | | | | | |
| | | with a silicone compound | | | | | | | |
| | | coating | | | | | | | |
| | | Flame-retardant particle 1 | | | | | | | |
| | | with an organic compound | | | | | | | |
| | | coating | | | | | | | |
| | | Flame-retardant particle 2 | | | | | 25 | | |
| | | with no coating | | | | | | | |
| | | Flame-retardant particle 2 | | | | | | | |
| | | with a silicone compound | | | | | | | |
| | | coating | | | | | | | |
| | | Flame-retardant particle 3 | | | | | | 25 | |
| | | with no coating | | | | | | | |
| | | Flame-retardant particle 3 | | 10 | | | | | 25 |
| | | with a silicone compound | | | | | | | |
| | | coating | | | | | | | |
| | Flame | Zinc borate (FLAMEBLEAK ZB, | | | | | | | |
| | retardant | manufactured by USBORAX) | | | | | | | |
| | aid | Silicone-based (DC4, | | | | | | | |
| | | manufactured by Dow | | | | | | | |
| | | Corning Toray Silicone) | | | | | | | |
| | | Nitrogen-based (Melapur MC, | | | | | | | |
| | | manufactured by Ciba-Geigy | | | | | | | |
| | | Corp.) | | | | | | | |
| | Total | | | 135 | 100 | 125 | 125 | 125 | 125 |
| Expansion ratio (%) | | | | 100 | 100 | 138 | 128 | 130 | 100 |
| Evaluation | Flame | Cone | Heat release rate | 200 | 2110 | Incapable of molding | | | 830 |
| results | retardancy | calorimeter | (KW/m²) | | | due to foaming | | | |
| | | UL-94 | | V-1 | Rejected | | | | Rejected |
| | Mechanical | Yield stress | MPa | 31 | 25 | | | | 12 |
| | properties | Bending | Gpa | 2.3 | 1.7 | | | | 1.9 |
| | | modulus | | | | | | | |

| | | | | |
|---|---|---|---|---|
| Total light | % | 52 | 98 | 38 |
| transmittance | | | | |

| | | | | | | |
|---|---|---|---|---|---|---|
| Appearance | Natural | Natural | Expanded | Expanded | Expanded | White |

The above results indicate that the flame-retardant resin compositions according to the invention containing flame-retardant particles and a flame retardant aid are higher in flame retardancy and lower in smoke generation, retain superior mechanical properties. It is also clear that the flame-retardant resin compositions according to the invention have superior flame retardancy and mechanical properties even when used in combination with a common flame retardant having a larger particle diameter.

We claim:

1. A flame-retardant resin composition comprising a biodegradable resin and flame-retardant particles having a volume average particle diameter in the range of 1 nm to 500 nm, wherein the flame-retardant particles contain a metal hydrate and have a coating layer containing an organic compound or a polysilicone.

2. The flame-retardant resin composition of claim 1, further comprising a flame-retardant aid dispersed in the biodegradable resin.

3. The flame-retardant resin composition of claim 1, wherein the metal hydrate is hydrate of at least one metal selected from Mg, Ca, Al, Fe, Zn, Ba, Cu, and Ni.

4. The flame-retardant resin composition of claim 1, wherein the flame-retardant particles are a combination of flame-retardant particles having a volume average particle diameter of 1 nm or larger but smaller than 200 nm and the flame-retardant particles having a volume average particle diameter of 200 nm to 500 nm.

5. The flame-retardant resin composition of claim 1, further comprising another flame retardant having a volume average particle diameter of larger than 0.5 μm but not larger than 50 μm dispersed in the biodegradable resin.

6. The flame-retardant resin composition of claim 1, wherein the flame-retardant resin composition has an expansion ratio of 100 to 103%.

7. A flame-retardant resin-molded article comprising a biodegradable resin and flame-retardant particles having a volume average particle diameter of 1 nm to 500 nm dispersed in the biodegradable resin, wherein the flame-retardant particles comprise a metal hydrate, and the flame-retardant resin-molded article has a flame retardancy of HB or higher according to the UL-94 test.

8. The flame-retardant resin-molded article of claim 7, wherein the flame-retardant resin-molded article has a heat generation rate which is lower than one-third of the heat generation rate of a molded article formed using the biodegradable resin which does not contain the flame-retardant particles, according to cone calorimeter measurement based on ISO5660.

9. The flame-retardant resin-molded article of claim 7, wherein the flame-retardant resin-molded article has a total light transmission of 40% to 90% according to JIS K7105.
